(19) United States
(12) Patent Application Publication
(10) Pub. No.: US 2012/0213612 A1
(43) Pub. Date: Aug. 23, 2012

(54) PAPER BINDER

(75) Inventor: Xiao Dong Wu, Tokyo (JP)

(73) Assignee: PLUS CORPORATION, Tokyo (JP)

(21) Appl. No.: 13/504,226

(22) PCT Filed: Oct. 15, 2010
(86) PCT No.: PCT/JP2010/006134

§ 371 Date: Apr. 26, 2012

(30) Foreign Application Priority Data
Oct. 29, 2009 (JP) 2009-249513

(51) Int. Cl. B42B 5/00

(52) U.S. Cl. 412/16

(57) ABSTRACT

An object is to provide a paper binder that is capable of securing a binding strength among sheets of paper. In a manner that, in accordance with the directions of projections held by a holder, the rotation directions of the projections and the projection directions of strips face each other, respectively, and an angle formed by the facing strips is within a range of substantially 90°-180°, the strips are folded.

### TECHNICAL FIELD

The present invention relates to a paper binder that is capable of piercing sheets of paper and binding the sheets of paper together. In particular, the present invention relates to a technique of binding sheets of paper with a tongue formed when the sheets of paper are pierced, without using a staple of a stapler or the like or adhesive paste.

### BACKGROUND ART

In general, as a paper binder that binds sheets of paper, a stapler is used. A stapler is a tool that is capable of sandwiching and pressing sheets of paper to make the tip of a staple pierce the sheets of paper and binding the sheets of paper together with the staple inserted into the piercing hole.

Such a stapler has the advantage of being capable of binding sheets of paper by simple work. Meanwhile, such a stapler has risk and disadvantage such that a staple may stick in the user's finger or the like. Moreover, work for removing the staple from the bound sheets of paper when shredding the sheets of paper is troublesome.

Further, the user may lose the staple removed from the sheets of paper. Furthermore, the user may put sheets of paper bound by a staple into an ADF (Auto Document Feeder) of a copier or the like or a shredder by mistake. Such a mistake may damage the ADF or the shredder.

There is also a proposal of a stapler using glue instead of staples (refer to Patent Document 1, for example). However, such a stapler has a problem that it is difficult for the user to supply or replace the glue. Moreover, it is difficult to configure such a stapler to be capable of smoothly applying the glue while increasing the strength of adhesion of sheets of paper bound by the glue.

As described above, the staplers have various problems. In response thereto, there is a conventional proposal of a paper binder that binds sheets of paper without using a binding material such as a staple or glue (refer to Patent Documents 2 and 3, for example). A paper binding process by the paper binder that uses no binding material is as described below, for example.

Firstly, in a state that sheets of paper are stacked in a like manner as a punch is used, the paper binder pierces the sheets of paper with a punch blade placed against the sheets of paper. However, different from a punch, this paper binder does not completely separate a piercing portion from the sheets of paper when piercing. To be specific, this paper binder is configured to cut only part of the respective sheets of paper (refer to FIGS. 1-3 and 6-8 of Patent Document 2). That is to say, after pierced by this paper binder, the sheets of paper are each divided into a tongue portion cut on the sheet of paper and a base portion (a base portion of the tongue portion) that is not separated from the sheet of paper.

Further, almost simultaneously with piercing, the paper binder forms an incision for receiving the tongue cut by the punch blade (refer to FIG. 2 of Patent Document 2). This incision is formed with a knife (refer to reference numeral 3 in FIG. 2 of Patent Document 2) adjacent to the punch blade. Additionally, by a cam (refer to reference numeral 5 in FIG. 2 of Patent Document 2) attached to the punch blade, the paper binder pushes the tongues of the sheets of paper together into the incision formed by the knife.

In this manner, sheets of paper are bound together by the paper binder. Since the bound sheets of paper are not provided with a binding material such as a staple, the user can put the sheets of paper into a shredder directly. Moreover, the user does not need to supply a binding material even if keeping on using the paper binder.

[Patent Document 1] Japanese Unexamined Patent Application Publication No. 2006-51648

[Patent Document 2] Japanese Patent Publication No. S41-3278

[Patent Document 3] Japanese Unexamined Patent Application Publication No. S56-51389

### DISCLOSURE OF THE INVENTION

### Problem that the Invention is to Solve

However, the binding strength of sheets of paper by the conventional paper binders of Patent Document 2 and 3 described above may be insufficient. This problem will be described with reference to FIGS. 16 and 17 attached hereto as well as FIGS. 1-3 and 6-8 of Patent Document 2. FIG. 16 is a schematic view showing a binding portion on sheets of paper bound by a tongue after piercing, for describing the binding strength in each flipping direction. FIG. 17 is a schematic view showing binding portions 300a and 300b by a conventional paper binder.

As described above, the conventional paper binders of Patent Documents 2 and 3 bind sheets of paper with a tongue obtained by piercing the sheets of paper. In this case, the binding strengths vary depending on directions in which the bound sheets of paper are flipped. The binding strength will be described with examples of flipping directions A-D with respect to the binding portion 300 shown in FIG. 16. The binding portion 300 in FIG. 16 is composed of a hole 301 and a tongue 302, which are formed by piercing part of each of the sheets of paper by the paper binder, and an insertion 303 that receives the tongue 302.

When a person (simply referred to as a “reader” hereinafter) who is reading bound sheets of paper flips the sheets of paper along the A-direction at the binding portion 300 as shown in FIG. 16, the tongue 302 easily slips from the incision 303 and is easily unbound from the binding portion 300. This is because the sheets of paper are flipped in the opposite direction to a direction in which the tongue 302 is received by the incision 303.

On the other hand, when the reader flips the sheets of paper along the B-direction, C-direction or D-direction in FIG. 16, the flipping operation affects little on the engagement state between the incision 303 and the tongue 302 received by the incision 303. With regard to the binding strength at the binding portion 300 of FIG. 16 against the flipping operation along the respective directions, the paper binder and paper binding method of Patent Documents 2 and 3 may cause the following problems.

In Patent Document 2 describing the paper binding method, two tongues (“tongues” denoted by reference numeral 25) closely arranged project in the same direction as shown in FIGS. 6-9 of this Document. In a case that this paper binding method is employed, when a sheet of paper is flipped along the A-direction (namely, the opposite direction to the projection direction of the tongues) with respect to the tongue 302 at the binding portion 300 shown in FIG. 16, the binding is easily unbound. Therefore, in the paper binding method of Patent Document 2, the binding strength of bound sheets of paper is weak.

Further, in a case that the paper binder of Patent Document 3 is employed, tongues (denoted by reference numeral 43a) shown in FIG. 15 of this Document project in directions away from each other. Therefore, the tongue 302a of the binding portion 300a shown in FIG. 17 is weak against the flipping operation along the A1-direction and is easily unbound. In a like manner, the tongue 302b of the binding portion 300b is weak against the flipping operation along the A2-direction and is easily unbound.

The present invention was made in consideration of the above problems, and an object of the present invention is to provide a paper binder that is capable of binding sheets of paper without using a binding material such as a staple, and that is capable of securing the binding strength of bound sheets of paper regardless of a direction in which the sheets of paper are flipped.

### Means for Solving the Problem

In order to solve the above task, the invention of Claim 1 is a paper binder configured to partially cut and pierce stacked sheets of paper, form incisions near pierced holes, and engage substantially tongue-like strips formed by partially cutting with the incisions to bind the sheets of paper. The paper binder comprises: a base; a pair of supporting plates erected from both sides of the base; a handling member supported by the supporting plates so as to be rotatable; a pair of punch blades configured to pierce the sheets of paper and form the strips; a pair of projections configured to be rotated in accordance with rotation of the handling member to hit the strips formed by the piercing and fold the strips toward the sheets of paper; a pair of incising blades configured to form the incisions with which the strips can be engaged on the sheets of paper; and a holder placed between the supporting plates, supported by the handling member or the base so as to be movable between the handling member and the base in accordance with rotation of the handling member, and configured to hold the punch blades and the projections and also hold the incising blades between the punch blades. In the paper binder, the strips are folded so that, in accordance with directions of the projections held by the holder, rotation directions of the projections and projection directions of the strips face each other, respectively, and an angle formed by the facing strips is within a range of substantially 90°-180°.

Further, in order to solve the above task, the invention of Claim 4 is a paper binder configured to a paper binder configured to partially cut and pierce stacked sheets of paper, form incisions near pierced holes, and engage substantially tongue-like strips formed by partially cutting with the incisions to bind the sheets of paper. The paper binder comprises: a base; a pair of supporting plates erected from both sides of the base; a handling member supported by the supporting plates so as to be rotatable; a pair of punch blades configured to pierce the sheets of paper and form the strips; a pair of projections configured to be rotated in accordance with rotation of the handling member to hit the strips formed by the piercing and fold the strips toward the sheets of paper; a pair of incising blades configured to form the incisions with which the strips can be engaged on the sheets of paper; and a holder placed between the supporting plates, supported by the handling member or the base so as to be movable between the handling member and the base in accordance with rotation of the handling member, and configured to hold the punch blades and the projections and also hold the incising blades between the punch blades. In the paper binder, the holder is configured to hold the projections so as to face each other and so that an angle formed by connecting directions of the projections is within a range of substantially 90°-180°.

### Effect of the Invention

In a case that the paper binders according to Claims 1 and 4 are employed, in accordance with the directions of the projections held by the holder, the projection directions of the strips of sheets of paper formed by piercing face each other. Moreover, on the sheets of paper bound by the paper binder, the strips are folded so that an angle formed by the facing strips is within a range of substantially 90°-180°. That is to say, since the angle formed by the facing strips is within the range of substantially 90°-180°, it is possible to prevent that the strips slips from the incisions even if the sheets of paper are flipped in the opposite direction to a direction each of the strips is inserted in and engaged with the incision. Therefore, it is possible to avoid that the binding is easily unbound depending on the flipping direction, and secure the binding strength of the sheets of paper. Moreover, since the sheets of paper are bound with the strips of the sheets of paper, it is possible to bind the sheets of paper without using a binding material.

### BRIEF DESCRIPTION OF THE DRAWINGS

FIG. 1A is a schematic perspective view showing the appearance of a paper binder according to a first embodiment.

FIG. 1B is a schematic perspective view of the paper binder seen from the opposite side to FIG. 1A.

FIG. 2A is a schematic top view perspectively showing the appearance and internal structure of the paper binder according to the first embodiment.

FIG. 2B is a schematic A-A cross-sectional view showing the outline of a tongue processor and so on before piercing, and showing the outline of a cross section A-A in FIG. 2A.

FIG. 3A is a schematic left side view showing that a handle of the paper binder of the first embodiment is pushed down.

FIG. 3B is a schematic A-A cross-sectional view taken on cross section A-A in FIG. 2A, and showing the outline of the tongue processor and so on in a state that the handle of the paper binder is pushed down, piercing is completed, and a tongue is folded and pushed in.

FIG. 4 is a schematic view conceptually showing a difference in width between an incising blade and a tongue formed by piercing in the first embodiment.

FIG. 5A is a schematic bottom view showing the paper binder of the first embodiment before rotation of the tongue processor.

FIG. 5B is a schematic bottom view showing the paper binder of the first embodiment after rotation of the tongue processor.

FIG. 6 is a schematic view showing a state that the corners of sheets of paper are bound by the paper binder of the first embodiment.

FIG. 7A is a schematic B-B cross-sectional view taken on cross section B-B in FIG. 2A, and showing the state of a pressing portion before rotation of the handle.

FIG. 7B is a schematic B-B cross-sectional view taken on cross section B-B in FIG. 2A, and showing the state of the pressing portion after rotation of the handle.

FIG. 8 is a schematic exploded perspective view showing the outline of the configuration and the connection relation of the respective components in the paper binder of the first embodiment.

FIG. 9A is a schematic perspective view showing the appearance of a paper binder according to a second embodiment.

FIG. 9B is a schematic perspective view of the appearance and internal structure of the paper binder seen from the opposite side to FIG. 9A.

FIG. 10A is a schematic left side view perspectively showing the internal structure of the paper binder before rotation of a handle in the paper binder according to the second embodiment.

FIG. 10B is a schematic A-A cross-sectional view showing the outline of a tongue processor and so on before piercing, and showing the outline of a cross section A-A in FIG. 10A.

FIG. 11 is a schematic A-A cross-sectional view taken on cross section A-A in FIG. 10A, and showing the outline of the tongue processor and so on in a state that the handle of the paper binder is pushed down, piercing is completed, and a tongue is folded and pushed in.

FIG. 12 is a schematic view showing a state that the edges of sheets of paper are bound by the paper binder of the second embodiment.

FIG. 13A is a schematic top view perspectively showing the appearance and internal structure of the paper binder according to the second embodiment.

FIG. 13B is a schematic B-B cross-sectional view taken on cross section B-B in FIG. 13A, and showing the state of a pressing portion before rotation of the handle.

FIG. 14 is a schematic B-B cross-sectional view taken on cross section B-B in FIG. 13A, and showing the state of the pressing portion after rotation of the handle.

FIG. 15 is a schematic view showing a state that the corners of sheets of paper are bound by a modified example of the paper binders of the embodiments.

FIG. 16 is a schematic view showing a binding portion on sheets of paper bound by a tongue after piercing by using a conventional paper binder.

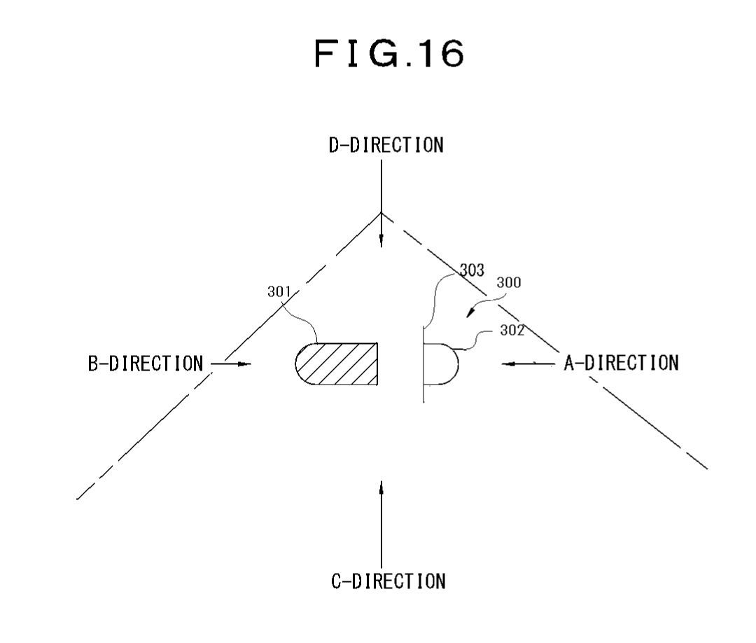

FIG. 17 is a schematic view showing a binding portion bound by a conventional paper binder.

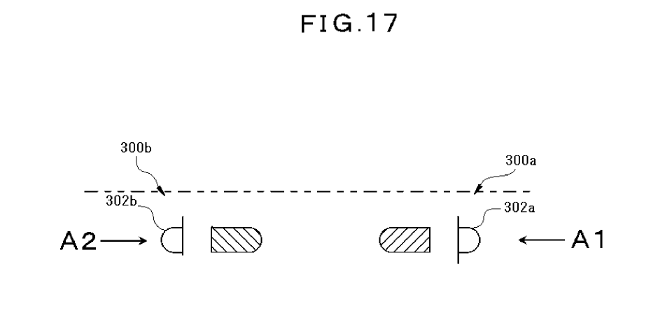

### MODE FOR CARRYING OUT THE INVENTION

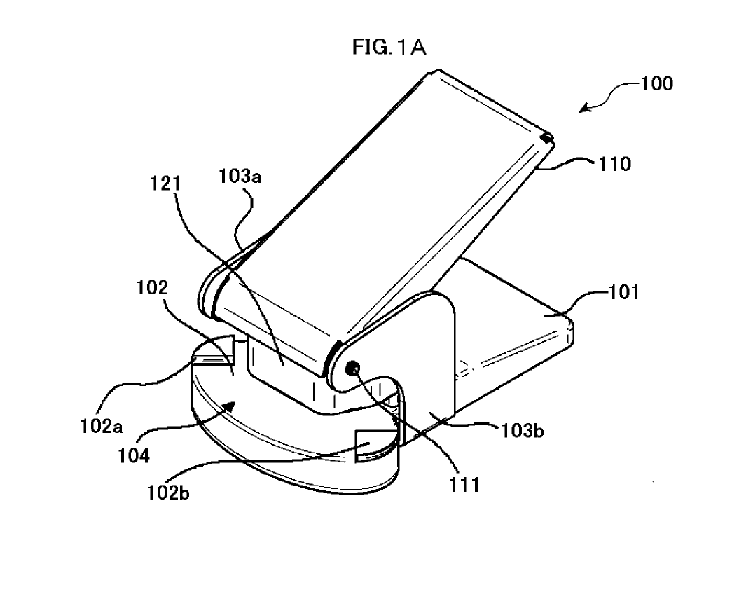

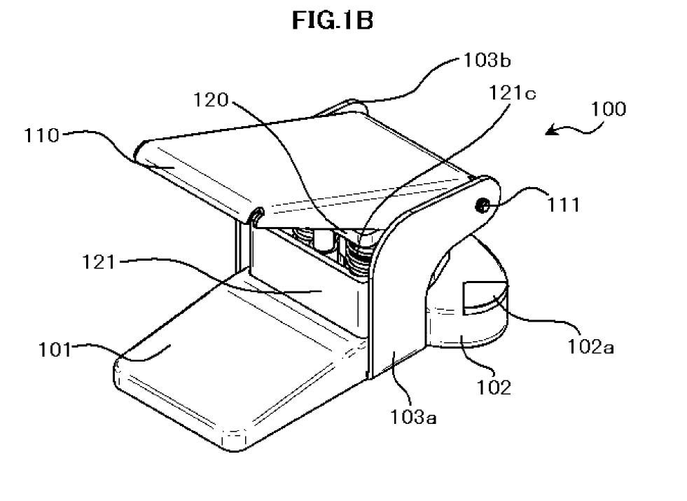

Below, embodiments of the present invention will be described with reference to FIGS. 1A-15.

### First Embodiment

### (Entire Configuration)

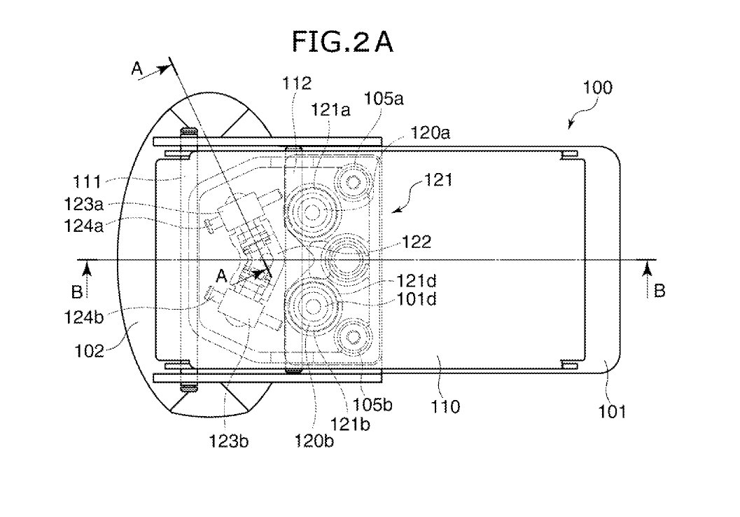

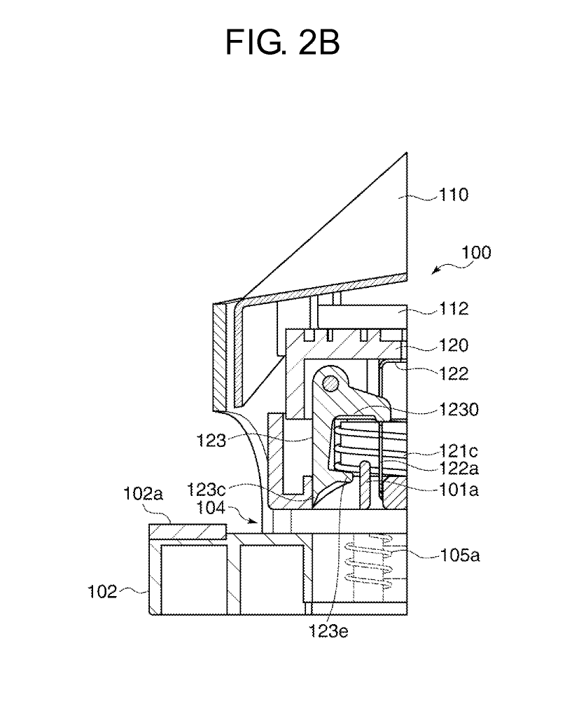

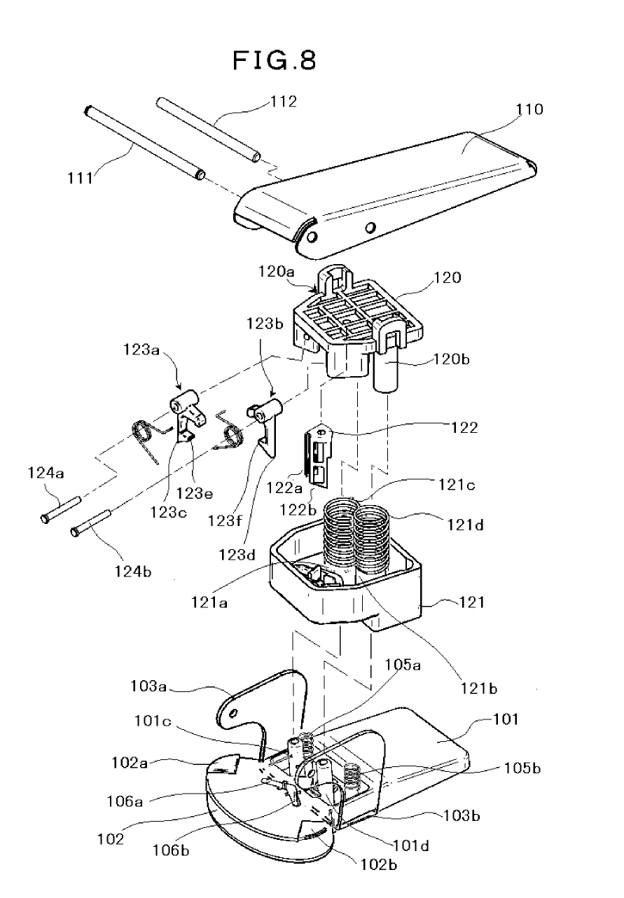

The outline of the entire configuration of a paper binder 100 according to a first embodiment of the present invention will be described with reference to FIGS. 1A and 1B. FIG. 1A is a schematic perspective view showing the appearance of the paper binder 100. FIG. 1B is a schematic perspective view of the paper binder 100 seen from the opposite side to FIG. 1A. The paper binder 100 pierces sheets of paper with a pair of punch blades (reference numerals 123c and so on in FIG. 2B) while leaving part of the respective sheets of paper so as not to be separated therefrom. Thus, the paper binder 100 firstly forms tongue-like (or quadrilateral) strips (hereinafter, simply referred to as “tongues”) that are left connected to the respective sheets of paper. In addition to piercing, the paper binder 100 forms a pair of incisions between a pair of holes formed by piercing, with a pair of incising blades (reference numerals 122a and so on in FIG. 8). After that, the paper binder 100 folds and pushes the respective tongues into the incisions. Thus, the paper binder 100 can bind the sheets of paper.

The outline of the appearance of the paper binder 100 will be described. As shown in FIGS. 1A and 1B, the paper binder 100 has, as a substructure (a foundation), a base 101 and a placement table 102 for placing sheets of paper. Moreover, on both sides of the base 101, a pair of supporting plates 103a and 103b are erected in a direction away from the base 101. The supporting plates 103a and 103b are erected so as to be parallel with each other and substantially orthogonal to the upper face of the base 101.

As shown in FIGS. 1A and 1B, the supporting plates 103a and 103b each have a substantially inverted L-shape with a tip end opposite to the base 101 bending to the side of the placement table 102 (hereinafter, referred to as a “rear side”). Moreover, to each of the tip ends of the supporting plates 103a and 103b, a handle 110 is connected. The handle 110 is connected to the supporting plates 103a and 103b via a rotation shaft 111. The rotation shaft 111 is almost parallel to the base 101. Moreover, the handle 110 is connected to the supporting plates 103a and 103b so as to be capable of rotating about the rotation shaft 111.

Further, as shown in FIG. 1B, between the handle 110 and the base 101, a top plate 120 and a pressing portion 121 are formed. The top plate 120 is placed on the handle 110. The pressing portion 121 is placed on the base 101. The pressing portion 121 is formed at a predetermined space from the placement table 102. In a region (a placement region) corresponding to this predetermined space, sheets of paper to be bound by the paper binder 100 are placed. Moreover, a rear-side end of the placement region is an insertion opening 104.

The base 101 and the placement table 102 are equivalent to an example of a “base” and an example of a “placement region” of the present invention. The handle 110 is equivalent to an example of a “handling member” of the present invention. The top plate 120 is equivalent to an example of a “top portion” of the present invention. The pressing portion 121 is equivalent to an example including a “bottom portion” of the present invention.

### (Outline of Operation)

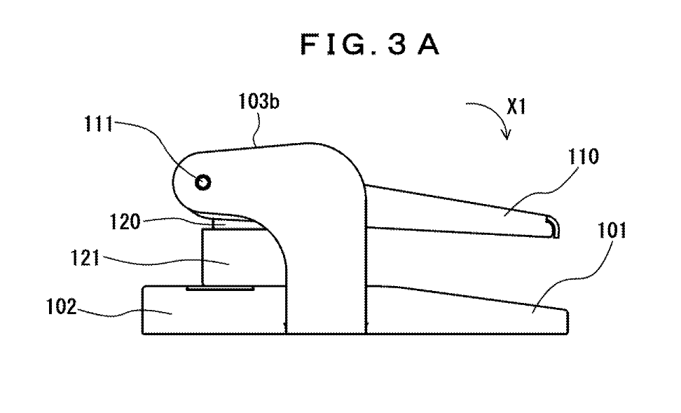

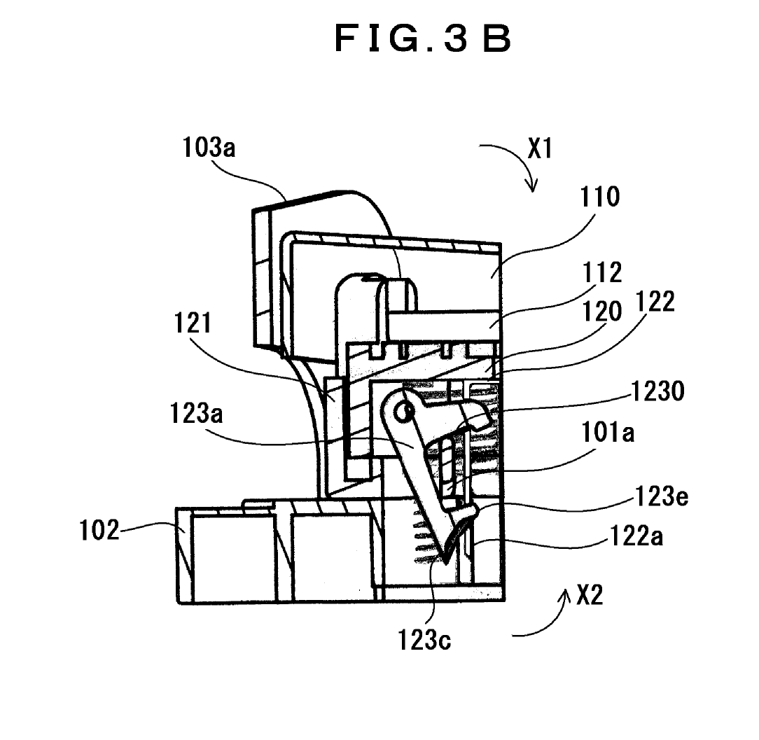

Next, the outline of a paper binding process by the paper binder 100 will be described with reference to FIGS. 2A, 2B, 3A and 3B.

FIG. 2A is a schematic top view perspectively showing the appearance and internal structure of the paper binder 100. In FIG. 2A, through the handle 110 and the top plate 120, the internal structure of a pressure shaft 112, the pressing portion 121, and so on are partially shown. FIG. 2B shows the outline of a tongue processor 123a and so on before piercing. FIG. 2B is a schematic A-A cross-sectional view showing the outline of the cross section at portion A-A in FIG. 2A. FIG. 3A is a schematic left side view showing a state that the handle 110 of the paper binder 100 is pushed down. FIG. 3B is a schematic A-A cross-sectional view taken on cross section A-A in FIG. 2A, and showing the outline of the tongue processor 123a and so on in a state that the handle 110 is pushed down, piercing is completed, and the tongues are folded and pushed in. In FIG. 3B, in order to make the drawing clear, sheets of paper to be bound are not shown.

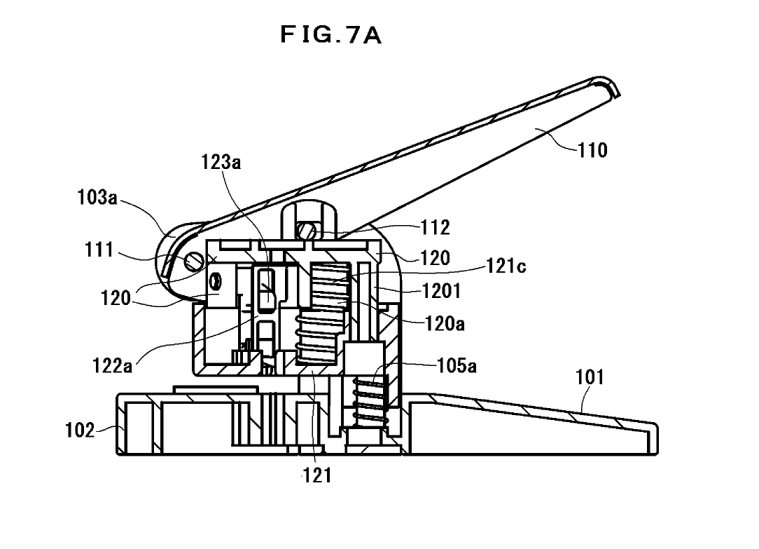

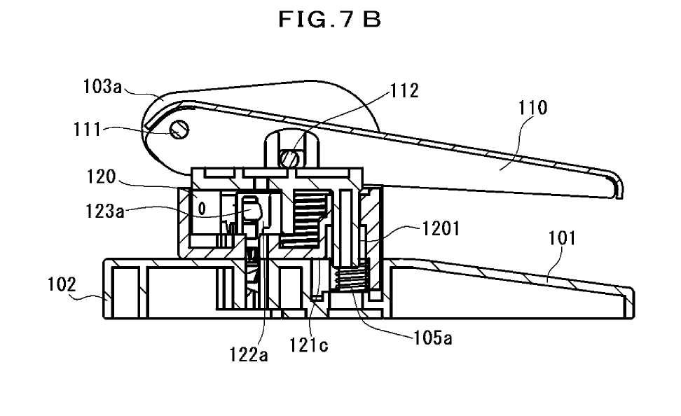

The pressure shaft 112 is supported by the handle 110. The pressure shaft 112 abuts against a face of the top plate 120 on the side of the handle 110 (hereinafter, referred to as an “upper face”). When the handle 110 is rotated toward the base 101, in accordance with the rotation, the pressure shaft 112 pushes down the top plate 120 against which the pressure shaft 112 abuts, toward the base 101. The top plate 120 is provided with substantially linear guide posts 120a (refer to FIG. 7A) and 120b (refer to FIG. 8) that project toward the base 101. The guide posts 120a and 120b are inserted into first tubes 121a and 121b of the pressing portion 121 as shown in FIG. 2A, respectively. Therefore, in accordance with the rotation of the handle 110, the top plate 120 is guided by the first tubes 121a and 121b to descend vertically (in a direction orthogonal to the upper face of the base 101).

Next, the outline of the configuration and operation of the incising blade 122a and the tongue processor 123a will be described. The incising blade 122a is a plate-like blade that forms incisions on sheets of paper. The tongue processor 123a forms tongues used for binding sheets of paper. Besides, the tongue processor 123a is a member that folds and pushes the formed tongues into the incisions and engages the tongues with the incisions. As shown in FIGS. 2B and 8, the incising blade 122a is held by the top plate 120 via an incising blade holder 122. The incising blade 122a extends from the top plate 120 toward the base 101 and the placement table 102.

The tongue processor 123a is supported on the top plate 120 so as to be rotatable. The rotation direction of the tongue processor 123a is, for example, a direction that inwardly inclines about 45°-90° with respect to a direction of insertion of sheets of paper. Herein, “the rotation direction inwardly inclines” refers to that the tongue processor 123a rotates toward a center line (line B-B in FIG. 2A) of the paper binder 100 connecting the rear side and front side of the paper binder 100. Moreover, with the axially supporting portion as a base portion, the tongue processor 123a projects toward the upper faces of the base 101 and the placement table 102. Moreover, a tip in the projection direction of the tongue processor 123a is formed into a substantially hook-like shape. The end portion on the side of the base portion of the tongue processor 123a is also formed into a substantially hook-like portion (refer to reference numeral 1230 in FIG. 3B) projecting in almost the same direction as the hook-like shape of the tip. Moreover, the tip of the substantially hook-like shape of the tongue processor 123a is composed of a punch blade 123c and a projection 123e. The projection 123e projects from the punch blade 123c in the rotation direction of the tongue processor 123a

When the handle 110 is pushed down as shown in FIG. 3A, the top plate 120 is pushed down via the pressure shaft 112, and further, the top plate 120 is guided and moved toward the base 101. When the top plate 120 is pushed down, the tongue processor 123a supported on the top plate 120 descends toward the base 101. The tongue processor 123a descends more via the top plate 120 and hits sheets of paper placed on the placement table 102 and the base 101. When the top plate 120 descends still more, the punch blade 123c at the tip of the tongue processor 123a having hit the sheets of paper pierces the sheets of paper. Besides, the incising blade 122a also descends and forms incisions on the sheets of paper at an inside position from the pierced site. “Inside” refers to a side closer to the center line (line B-B in FIG. 2A) of the paper binder 100 connecting the rear side and front side of the paper binder 100.

When the tongue processor 123a descends still more, the lower face (a face on the side of the base 101) of the hook-like portion (refer to reference numeral 1230 in FIG. 3B) on the side of the base portion of the tongue processor 123a hits the tip of a raised portion 101a of the base 101. Consequently, as shown in FIG. 3B, the tongue processor 123a rotates in a substantially front-face direction (an X2-direction in FIG. 3B). When the tongue processor 123a rotates, the tongues formed by piercing are folded upward (toward the top plate 120) by the projection 123e. The folded tongues are pushed into the incisions. The tongues pushed into the incisions are engaged with the incisions. Thus, the sheets of paper are bound.

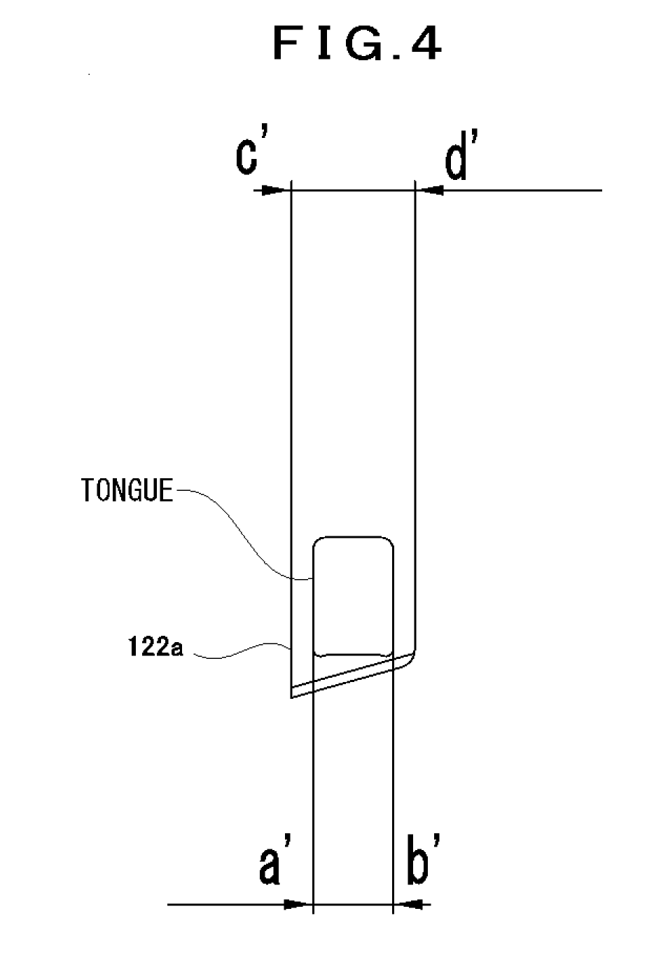

As shown in FIG. 4, for example, a relation between the width of the incision and the width of the tongue is as follows. FIG. 4 is a schematic view that conceptually shows a difference in width between the incising blade 122a, 122b and the tongue formed by piercing in the paper binder 100. For the sake of convenience in explanation, as shown in FIG. 4, the width of the tongue shall be denoted by symbol a′b′. Moreover, the width of the incision shall be denoted by symbol c′d′ on the assumption that the width of the incision is equal to the width of the incising blade 122a, 122b. Since the tongue is inserted into the incision, the relation between the width of the incision and the width of the tongue is represented as c′d′>a′b′.

For securing a binding strength by fixing the tongue engaged in the incision so as not to move, the width of the incision and the width of the tongue become almost the same (c′d′−a′b′=0 mm). On the other hand, the reader flips and reads the bound sheets of paper one by one. Therefore, in a case that the width of the incision and the width of the tongue are almost the same, flipping the sheets of paper places a large load on a contact point between the width end portion of the incision and the width end portion of the tongue, and the end portion of the incision may be broken. Thus, in consideration of the strength of the end portion of the incision, a difference in width between the incision and the tongue can be set to, for example, 2 mm or more. That is to say, it is possible to form the incising blades 122a and 122b so that a length between each of the width end portions of the tongue and each of the width end portions of the incision is 1 mm.

### (Tongue Processor and Punch Blade Guide)

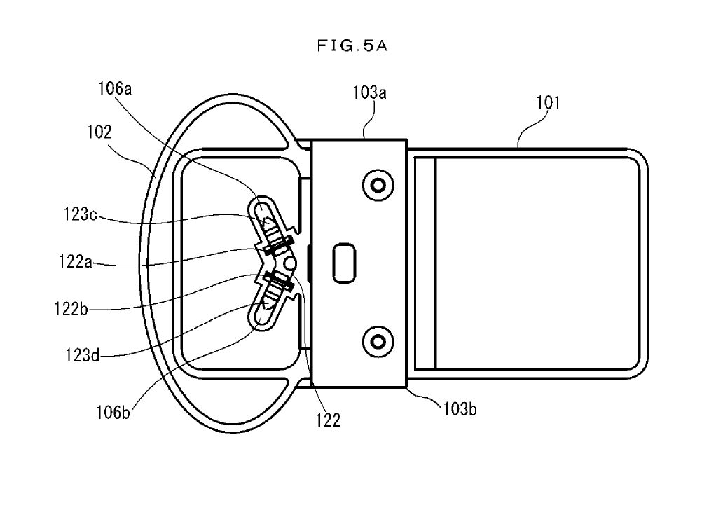

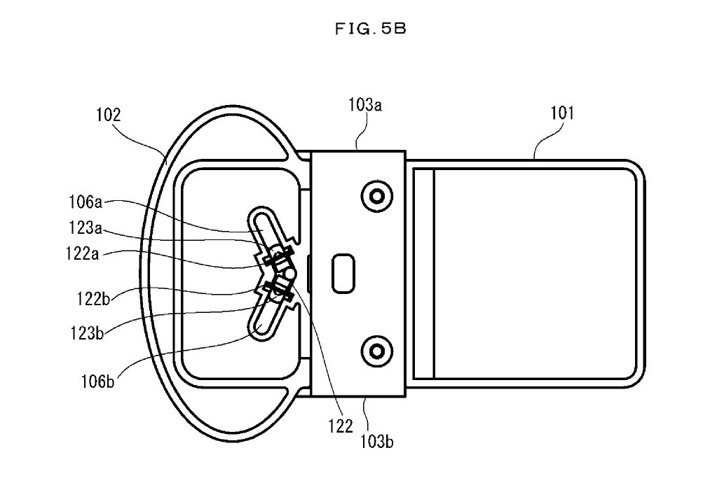

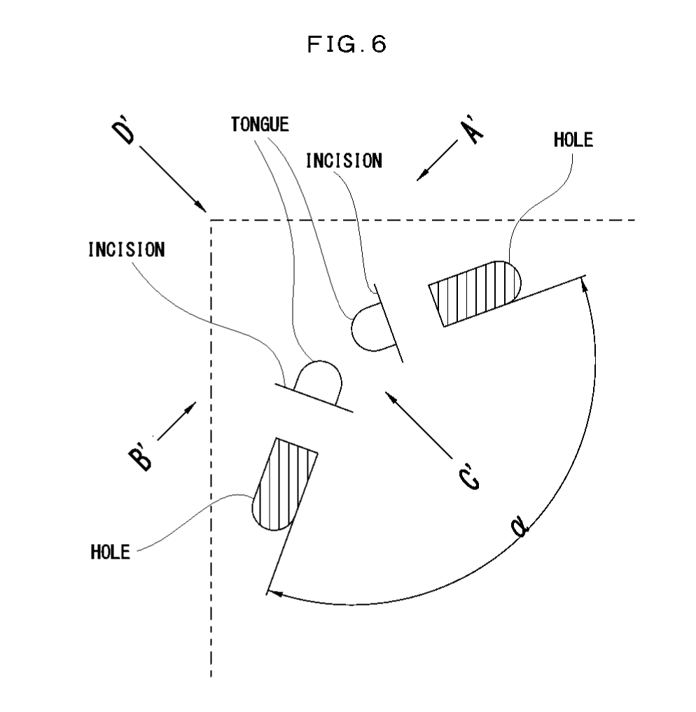

Next, with reference to FIGS. 5A, 5B and 6, the tongue processors 123a and 123b, the rotation directions thereof, and the connection directions thereof to the top plate 120 will be described. Moreover, punch blade guides 106a and 106b of the placement table 102 will be described. The punch blade guides 106a and 106b guide the punch blades 123c and 123d, respectively. FIG. 5A is a schematic bottom view showing a state before rotation of the tongue processors 123a and 123b in the paper binder 100. FIG. 5B is a schematic bottom view showing a state after rotation of the tongue processors 123a and 123b in the paper binder 100. FIG. 6 is a schematic view showing a state that the corners of sheets of paper are bound by the paper binder 100.

As shown in FIG. 5A, in the paper binder 100, at positions slightly closer to the front face from the center of the placement table 102, the punch blade guides 106a and 106b are passed through the lower face from the upper face of the placement table 102 (refer to lower part in FIG. 8 as necessary). The punch blade guides 106a and 106b guide descent and rotation of the punch blades 123c and 123d. As apparent from the placement of the punch blade guides 106a and 106b, the tongue processor 123a and the tongue processor 123b form a predetermined angle α (FIG. 6) and are supported on the top plate 120. That is to say, virtual extensions connecting the directions of the punch blades 123c and 123d and the rotation directions of the projections 123e and 123f form the predetermined angle α.

Further, the incising blades 122a and 122b are formed so as to be sandwiched by the punch blades 123c and 123d. The incising blades 122a and 122b are supported by the top plate 120. The blade directions of the incising blades 122a and 122b are substantially orthogonal to the rotation directions of the projections 123e and 123f, respectively. With the configuration as described above, the punch blades 123c and 123d rotate in mutually facing directions and fold the respective tongues. As a result, as shown in FIG. 5B, the tongues formed by the punch blades 123c and 123d are folded in the mutually facing directions in accordance with the rotation of the tongue processors 123a and 123b (refer to FIG. 2A). Moreover, since the incising blades 122a and 122b are substantially orthogonal to the rotation directions of the projections 123e and 123f, the incising blades 122a and 122b can push the tongues folded by the projections 123e and 123f into the incisions.

As a result, as shown in FIG. 6, the tongues engaged with the incisions face each other, and the virtual extensions in the projection directions of the tongues face or cross each other. Further, as described above, the tongue processors 123a and 123b are attached to the top plate 120 so that an angle formed by lines along the rotation directions of the tongue processors 123a and 123b becomes the predetermined angle α. In the paper binder 100 of this embodiment, the predetermined angle α shall be about 90°-180°. The angle α is an angle seen along the direction of insertion of sheets of paper into the paper binder 100 as shown in FIG. 6. With the angle α less than 180°, for example, about 90°-150°, it is possible to favorably bind the corners of sheets of paper. In case there is print or the like in a region of the corners of bound sheets of paper, there is a fear that the print cannot be recognized when the tongue or the pierced hole overlaps the print. Meanwhile, it is possible to avoid such a situation with the angle a of about 90°-150°, for example.

By thus defining the angle α, it is possible to avoid making a flipping direction in which the binding is easily unbound. That is to say, even when sheets of paper are flipped in the opposite direction to a direction of insertion of one of the tongues into one of the incisions, the other tongue engaged in the other incision can inhibit or prevent the sheets of paper from removing the tongue from the incision. Therefore, it is possible to secure the binding strength of sheets of paper. Moreover, since the sheets of paper are bound with the tongues, it is possible to bind the sheets of paper without using a binding material such as a staple or adhesive paste. Thus, it is possible to avoid a situation that a shredder or an ADF (Auto Document Feeder) is damaged. Besides, since it is unnecessary to supply a binding material, it is possible to avoid complicated work for replacing the binding material even when continuously using the paper binder.

### (Pressing Portion)

Next, with reference to FIGS. 7A and 7B, the paper binder 100 will be described. FIG. 7A is a schematic B-B cross-sectional view taken on cross section B-B in FIG. 2A, and showing the state of the pressing portion 121 before rotation of the handle 110. FIG. 7B is a schematic B-B cross-sectional view taken on cross section B-B in FIG. 2A, and showing the state of the pressing portion 121 after rotation of the handle 110.

In the paper binder 100, the guide post 120a (FIG. 7A) and the guide post 120b (FIG. 8) that project from the lower face of the top plate 120 toward the base 101 and the placement table 102 are formed. The guide posts 120a and 120b are inserted into the first tubes 121a and 121b (FIG. 8) that project from the pressing portion 121 toward the top plate 120. With this insertion configuration, the top plate 120 descends while being guided by the first tubes 121a and 121b. Furthermore, a first elastic member 121c (FIGS. 7A and 8) is formed between the top plate 120 and the pressing portion 121, around the guide post 120a and the first tube 121a. In a like manner, a first elastic member 121d is formed around the guide post 120b and the first tube 121b (FIG. 8). As the first elastic members 121c and 121d, for example, coil springs or rubber members are used.

Further, in a state that the handle 110 is most away from the base 101, the lengths of the first elastic members 121c and 121d are almost the same as a distance between the top plate 120 and the pressing portion 121. However, this length of the first elastic member 121c is merely one example, and the configuration of the paper binder 100 is not limited to this one. With this configuration, when the top plate 120 is pushed down, the first elastic members 121c and 121d shrink against the pressing force.

With such a configuration, before a point of time that piercing sheets of paper starts, the sheets of paper placed on the placement table 102 and the base 101 are pressed by the pressing portion 121 (FIG. 7B). Therefore, it is possible to hold the whole sheets of paper without making the sheets of paper misaligned when piercing the sheets of paper is started. That is to say, the sheets of paper bound by the paper binder 100 are hard to be misaligned. As a result, it is possible to finish binding the sheets of paper in a tidy state. Furthermore, since the sheets of paper are hard to be misaligned, it is possible to ensure a binding strength

Furthermore, a projecting portion 1201 that projects toward the base 101 is formed on the top plate 120 on the front side (FIG. 7A). The length of the projecting portion 1201 is shorter than the longest distance between the top plate 120 and the pressing portion 121, and slightly longer than the shortest distance therebetween, for example. Moreover, second elastic members 105a and 105b that hit the projecting portion 1201 are formed on the base 101 at positions corresponding to the projecting portion 1201 (FIGS. 7A and 8).

Accordingly, after the pressing portion 121 presses and holds the sheets of paper placed on the placement table 102 and the base 101, the projecting portion 1201 hits the second elastic members 105a and 105b. When the paper binder 100 starts piercing the sheets of paper, the projecting portion 1201 and the second elastic members 105a and 105b support adjustment of the piercing load (FIG. 7B). That is to say, the paper binder 100 holds the sheets of paper in a first stage, and pierces the held sheets of paper in a state that adjustment of the piercing load is supported in a second stage. As a result, the bound sheets of paper are hard to be misaligned. Thus, a tidy finish is achieved and a binding strength is secured.

### (Gauge Table)

Next, with reference to FIGS. 1A and 8, gauge tables 102a and 102b of the paper binder 100 will be described. As shown in FIG. 1A, at both side ends of the upper face (a face closer to the top plate 120) of the placement table 102, gauge tables 102a and 102b are formed in pairs. The respective gauge tables 102a and 102b are raised from the upper face of the placement table 102, and the upper face of each raised portion is formed into a flat shape. The gauge tables 102a and 102b are favorable members for binding the corners of sheets of paper. The gauge tables 102a and 102b guide so that the corners of the sheets of paper are kept at the positions of the punch blade guides 106a and 106b (FIG. 8). That is to say, the gauge tables 102a and 102b are formed so that the corners of sheets of paper inserted toward an intersection of the punch blade guides 106a and 106b matches the position of this intersection. The user can easily perform positioning for binding the corners of sheets of paper by inserting the sheets of paper toward the punch blade guides 106a and 106b along the side faces of the gauge tables 102a and 102b.

Furthermore, the height of each of the gauge tables 102a and 102b is lower than the height from the base 101 and placement table 102 to the pressing portion 121. Therefore, when not desiring to use the gauge tables 102a and 102b, the user can put sheets of paper on the gauge tables 102a and 102b for piercing. On the contrary, when using the gauge tables 102a and 102b, the user can perform the abovementioned positioning. That is to say, the gauge tables 102a and 102b are configured so that the positioning can be performed as necessary, and it is possible to bind sheets of paper depending on a using method required by the user.

### (Configuration of Each Component)

Next, with reference to FIG. 8, the outline of connection configuration of each component in the paper binder 100 will be described. FIG. 8 is a schematic exploded perspective view showing the outline of connection configuration of each component in the paper binder 100.

As shown in FIG. 8, the handle 110 is provided with first holes and second holes. Into the first holes, a rotation shaft 111 is inserted on the rear side. Into the second holes, a pressure shaft 112 is inserted between the first holes and the tip of the handle 110. On the respective supporting plates 103a and 103b, insertion holes are formed at positions corresponding to the respective first holes. Into the insertion holes, the rotation shaft 111 is inserted. Thus, the rotation shaft 111 is inserted into the handle 110 and the supporting plates 103a and 103b in parallel to the placement table 102 and the base 101.

Both ends of the pressure shaft 112 inserted into the second holes of the handle 110 are engaged with the top plate 120. With this configuration, the handle 110 supports the top plate 120. To the top plate 120, the tongue processors 123a and 123b are connected via rotation shafts 124a and 124b. The faces of the top plate 120 to which the tongue processors 123a and 123b are connected are formed so that the projection 123e and the projection 123f form an angle α. The incising blade holder 122 is connected to the top plate 120 so that the incising blades 122a and 122b are placed between the projections 123e and 123f.

An engagement relation among the guide posts 120a and 120b, the first elastic members 121c and 121d, and the first tubes 121a and 121b is as described above.

The pressing portion 121 is engaged with the second tubes 101c and 101d of the base 101 from the bottom side of the first tubes 121a and 121b.

### (Actions and Effects)

Next, actions and effects of the paper binder 100 will be described.

The paper binder 100 is configured not to make a direction in which the binding is easily unbound, by setting the predetermined angle α to 90°-180°. That is to say, even when sheets of paper are flipped in the opposite direction to a direction of insertion of one of the tongues into one of the incisions, the other tongue engaged with the other incision inhibits or prevents the sheets of paper from removing the tongue from the incision. Therefore, it is possible to secure the binding strength of sheets of paper. Moreover, since the sheets of paper are bound with the tongues, it is possible to bind the sheets of paper without using a binding material such as a staple or adhesive paste. Thus, it is possible to avoid a situation that a shredder or an ADF (Auto Document Feeder) is damaged. Besides, since it is unnecessary to supply a binding material, it is possible to avoid complicated work for replacing the binding material even when continuously using the paper binder.

Further, in the paper binder 100, a difference between the width of the incision and the width of the tongue is set to about 2 mm, for example. That is to say, the widths of the incising blades 122a and 122b are set so that a length between each end of the tongue in the width direction and each end of the incision in the width direction is about 1 mm. Thus, large load will not be placed on a contact point between the end of the incision in the width direction and the end of the tongue in the width direction when sheets of paper are flipped one by one, and therefore, it is possible to prevent the end of the incision from being broken.

Further, the paper binder 100 holds sheets of paper in a first stage, and pierces the held sheets of paper in a state that the piercing load is adjusted in a second stage. As a result, the bound sheets of paper are hard to be misaligned. Thus, a tidy finish is achieved and a binding strength is secured. Besides, as shown in FIG. 6, in the paper binder 100 of this embodiment, the angle α formed by the tongues is less than 180°, for example, about 90°-150°, it is possible to favorably bind the corners of sheets of paper. That is to say, it is possible to avoid a fear that a print portion in a region of the corners of bound sheets of paper becomes hard to see.

### Second Embodiment

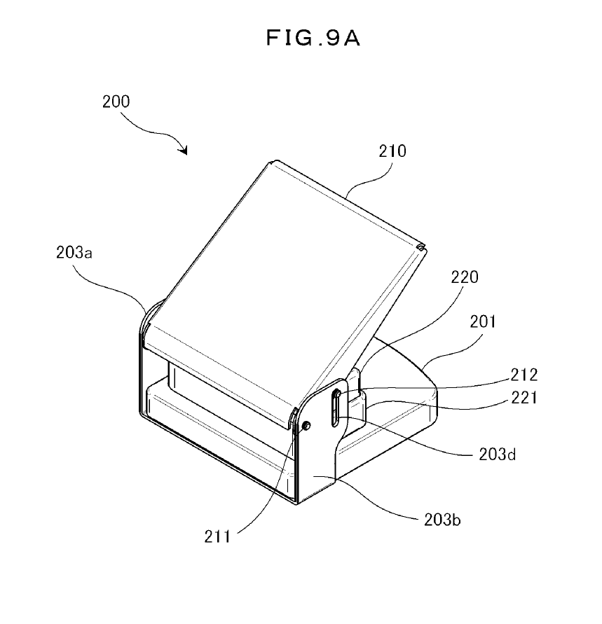

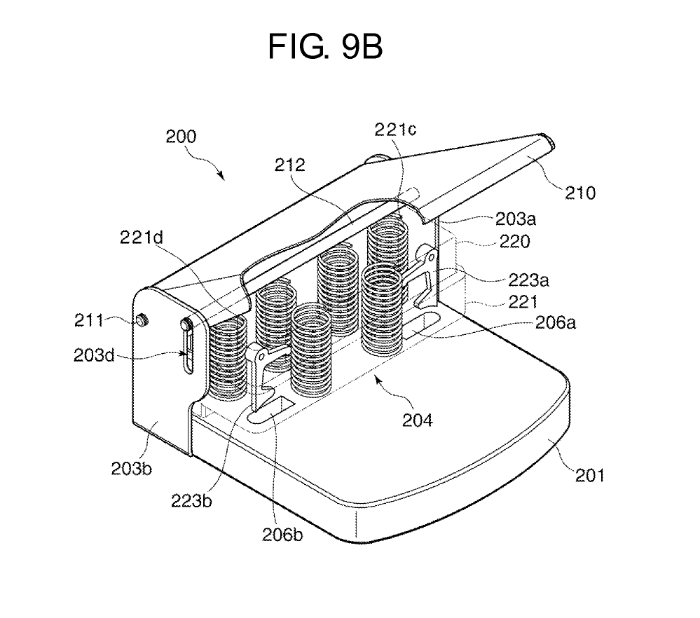

Next, a paper binder 200 according to a second embodiment of the present invention will be described with reference to FIGS. 9-14. FIG. 9A is a schematic perspective view showing the appearance of the paper binder 200. FIG. 9B is a schematic perspective view of the appearance and internal structure of the paper binder 200 seen from the opposite side to FIG. 9A.

### (Entire Configuration)

The paper binder 200 has a basic configuration that is common to the paper binder 100 according to the first embodiment. That is to say, the paper binder 200 is provided with a pair of supporting plates 203a and 203b with a base 201 as a substructure. However, in the paper binder 200, the base 201 also serves as a placement table, or a placement table is not formed. Moreover, a rotation shaft 211 is inserted between the supporting plates 203a and 203b. A handle 210 is supported by the supporting plates 203a and 203b via the rotation shaft 211 so as to be rotatable. The handle 210 has a tip that projects in a direction away from the base 201 (obliquely upward).

### (Supporting Plate)

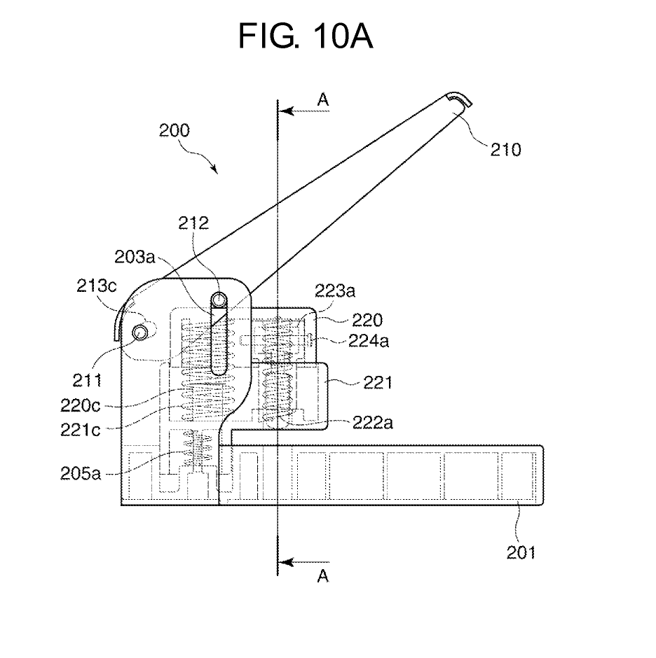

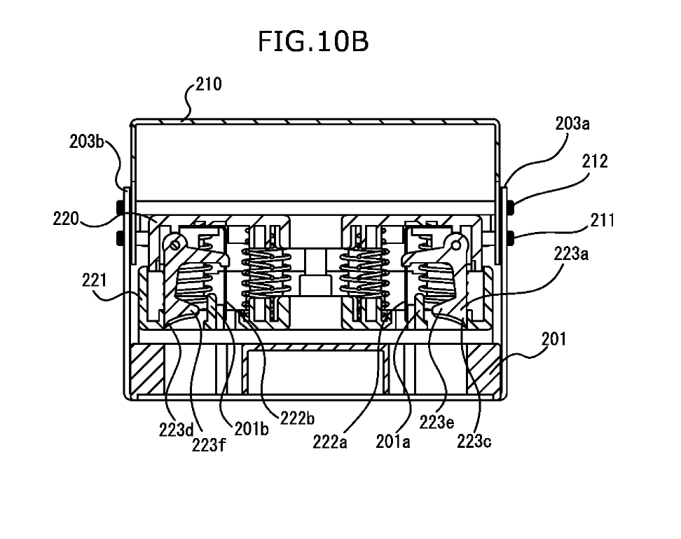

The supporting plates 203a and 203b each have a long hole into which the rotation shaft 211 is inserted (refer to reference numeral 213d in FIG. 10). The long hole is formed so as to have a width and a length that are longer than the diameter of the rotation shaft 211. Thus, the rotation shaft 211 has allowance with respect to the long hole. Moreover, the supporting plates 203a and 203b are each provided with a guide hole (refer to reference numeral 203d) that guides a pressure shaft 212. The pressure shaft 212 is inserted through the handle 210 to push down a top plate 220 as the handle 210 rotates. This guide hole is a linear long hole with a direction orthogonal to the upper face of the base 201 as a length direction. Moreover, both ends of the guide hole are each formed like an arc (a semicircle). Moreover, the width of the guide hole is slightly larger than the diameter of the pressure shaft 212 so that the pressure shaft 212 is inserted in the manner of being capable of reciprocating. Moreover, the long hole is formed on the side where the base portion of the handle 210 is placed. Moreover, the upper end of the guide hole is formed near a line connecting the tip of the handle 210 and the long hole.

### (Insertion Opening)

In the paper binder 200, the top plate 220 and a pressing portion 221 are formed between the handle 210 and the base 201, as in the paper binder 100 according to the first embodiment. Moreover, the pressing portion 221 is formed at a predetermined space from the base 201. This space is an insertion opening 204 for sheets of paper. In the paper binder 200, a direction of insertion of sheets of paper is a direction from the front side to the rear side. At this point, the paper binder 200 is like a general piercing punch. This insertion direction is opposite to the direction of insertion of sheets of paper in the paper binder 100 according to the first embodiment.

### (Supporting Structure of Rotation Shaft and Pressure Shaft)

Next, a supporting structure of the rotation shaft 211 and the pressure shaft 212 on the supporting plates 203a and 203b and the handle 210 will be described with reference to FIGS. 9A, 9B and 10A. FIG. 10A is a schematic left side view that perspectively shows a state of the internal structure of the paper binder, such as a tongue processor 223a, before the handle 210 of the paper binder 200 rotates.

### (Axis Supporting Structure of Supporting Plate)

The rotation shaft 211 is inserted and supported in rotation shaft holes on the supporting plates 203a and 203b. As shown in FIG. 9A, the rotation shaft hole has a substantially circular shape. Moreover, the diameter of the rotation shaft hole is slightly larger than the diameter of the rotation shaft 211. Thus, the rotation shaft 211 can rotate in a state that the axial center position is substantially not displaced with respect to the supporting plates 203a and 203b.

Further, the rotation shaft hole is formed on the perpendicular bisector of a line segment that connects the upper end and the lower end in the longitudinal direction of the guide hole 203d on each of the supporting plates 203a and 203b. That is to say, the rotation shaft hole is positioned so that a substantially isosceles triangle is formed with a line segment connecting the upper and lower ends of the guide hole 203d as the base and the rotation shaft hole as the vertex (FIG. 10A).

### (Axis Supporting Structure of Handle)

Further, as shown in FIG. 10A, the handle 210 is provided with the long holes 213d and pressure shaft holes. Into the long holes 213d, the rotation shaft 211 is inserted. Into the pressure shaft holes, the pressure shaft 212 is inserted. The long holes 213d are formed at positions on the handle 210 corresponding to the rotation shaft holes on the supporting plates 203a and 203b. As shown in FIG. 10A, before rotation of the handle 210, the long hole 213d is inclined to the upper end of the guide hole 203d with respect to the guide hole 203d.

Further, the long hole 213d has allowance of width with respect to the rotation shaft 211. Therefore, the rotation shaft 211 can move within the range of the long hole 213d. Consequently, it is possible to absorb frictional force of the pressure shaft on the guide hole 203d. Besides, the long hole 213d is formed so that a distance between the rotation shaft 211 (fulcrum) and the pressure shaft 212 (point of action) is not too far, namely, the movement amount of the rotation shaft 211 is minimum. That is to say, the long hole 213d reduces the frictional force to reduce a necessary load for piercing.

Further, the diameter of the pressure shaft hole is set to a size corresponding to the diameter of the pressure shaft 212 so that the axial center position of the pressure shaft 212 is maintained. Maintaining the axial center position fixes a positional relation between the pressure shaft 212 and the handle 210. Consequently, force applied to the handle 210 (point of effort) is efficiently transmitted to the pressure shaft 212 (point of action).

Accordingly, since the paper binder 200 is capable of reducing a necessary load for piercing, it is possible to save labor to pierce. Firstly, when the handle 210 is rotated, the long hole 213d having play adjusts the positional relation between the handle 210 and the rotation shaft 211. Consequently, frictional force generated between the pressure shaft 212 and the guide hole 203d is reduced. Secondly, at a point of time that the punch blade 223d and so on starts piercing, namely, a point of time that the pressure shaft 212 locates in the middle of the guide hole 203d, the rotation shaft 211 is in the closest position to the guide hole 203d by action of the play of the long hole 213d. Thus, by making the fulcrum and the point of action as close as possible to each other, it is possible to make force applied to the handle 210 efficiently act.

### (Outline of Operation)

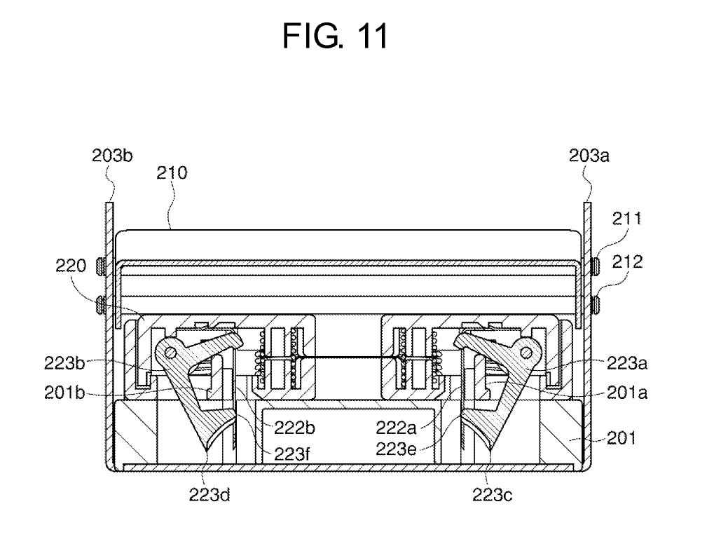

Next, the outline of a process of binding sheets of paper by the paper binder 200 will be described with reference to FIGS. 10A, 10B and 11. With regard to the configuration common to the paper binder 100 according to the first embodiment, only the outline thereof will be described. FIG. 10B is a schematic A-A cross-sectional view showing the outline of a tongue processor and so on before piercing, and showing the outline of a cross section A-A in FIG. 10A. FIG. 11 is a schematic A-A cross-sectional view taken on cross section A-A in FIG. 10A, and showing the outline of the tongue processor and so on in a state that the handle of the paper binder is pushed down, piercing is completed, and a tongue is folded and pushed in.

When the handle 210 is rotated toward the base 201, the top plate 220 against which the pressure shaft 212 abuts is, in accordance with this rotation operation, pushed down toward the base 201. The top plate 220 is provided with a plurality of guide posts (refer to FIG. 10B) that project toward the base 201. The respective guide posts are inserted into the first tubes (not shown) of the pressing portion 221. With the guide posts and the first tubes, the top plate 220 is guided in accordance with rotation of the handle 210, and descends perpendicularly (in a direction orthogonal to the upper face of the base 201).

The configuration and operation of the incising blade 222a and the tongue processor 223a are similar to those in the first embodiment. That is to say, in the course of change from the state shown in FIG. 10B to the state shown in FIG. 11, when the handle 210 is pushed down, the top plate 220 is guided and pushed down toward the base 201. When the top plate 220 is pushed down, the tongue processor 223a descends and the punch blade 223c pierces sheets of paper. Moreover, the incising blade 222a also descends and forms an incision at an inside position from the pierced position on the sheets of paper.

The tongue processor 223a descends more and hits the tip of a raised portion 201a. As a result, as shown in FIG. 11, the tongue processor 223a rotates in a direction substantially orthogonal to an insertion direction of the sheets of paper, and folds a tongue with a projection 223e. The folded tongue is pushed into the incision. The tongue having been pushed in is engaged with the incision. Thus, the sheets of paper are bound. A relation between the width of the incision and the width of the tongue is similar to that of the first embodiment, and therefore, a description thereof will be omitted.

### (Rotation Direction of Tongue Processor and Punch Blade Guide)

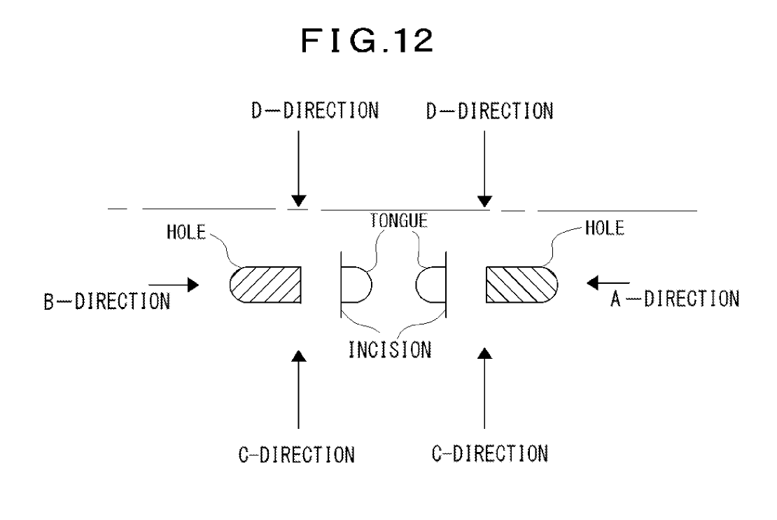

Next, with reference to FIGS. 9B, 10B, 11 and 12, a rotation direction of the tongue processors 223a and 223b and a connection direction thereof to the top plate 220 will be described. Besides, with reference to these drawings, the punch blade guides 206a and 206b on the base 201, which guide the punch blades 223c and 223d, will be described. FIG. 12 is a schematic view showing a state in which the edges of sheets of paper are bound by the paper binder 200.

As shown in FIG. 9B, the paper binder 200 is provided with the punch blade guides 206a and 206b. The punch blade guides 206a and 206b are located on the rear side of the base 201, and guide descent and rotation of the punch blades 223c and 223d. As shown in FIGS. 9B, 10A and 11B, the tongue processor 223a is attached to the top plate 220 so as to be substantially linear with the tongue processor 223b. That is to say, the tongue processors 223a and 223b are attached to the top plate 220 so that projections 223e and 223f face each other and an angle formed by virtual extensions in the projection directions of the projections 223e and 223f form is substantially 180°. Therefore, tongues formed by the punch blades 223c and 223d are folded in the facing directions each other (refer to FIG. 10B), by rotation of the tongue processors 223b and 223d.

As a result, as shown in FIG. 12, the tongues engaged with the incisions face each other, and the extensions in the projection directions of the tongues face each other.

By thus applying the angle 180°, it is possible to avoid making a flipping direction in which the binding is easily unbound. That is to say, it becomes difficult to flip sheets of paper in the opposite direction to a direction that one of the tongues is inserted into one of the incisions, and the other tongue engaged with the other incision can inhibit or prevent the sheets of paper from removing the tongue from the incision. Therefore, it is possible to secure the binding strength of sheets of paper. Moreover, since the sheets of paper are bound by the tongues, it is possible to bind the sheets of paper without using a binding material. Thus, it is possible to avoid a situation that a shredder or an ADF of a copier is damaged. Besides, since it is unnecessary to supply a binding material, it is possible to avoid complicated work for replacing the binding material even when continuously using the paper binder.

### (Top Plate and Pressing Portion)

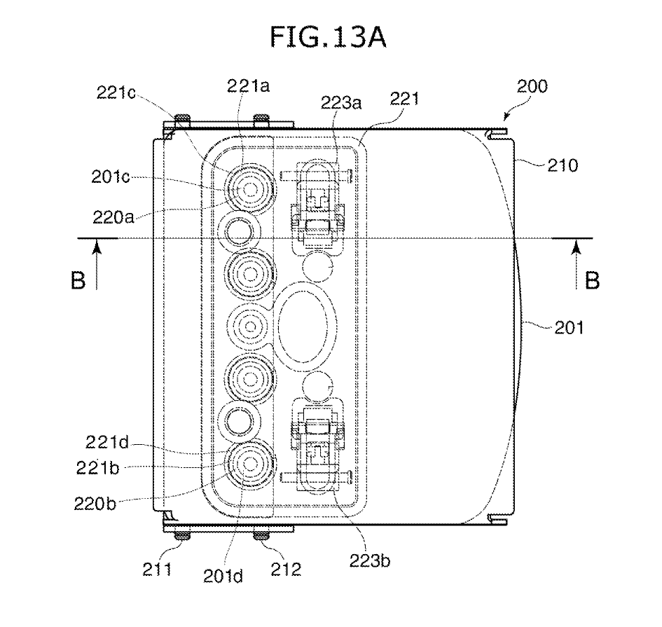

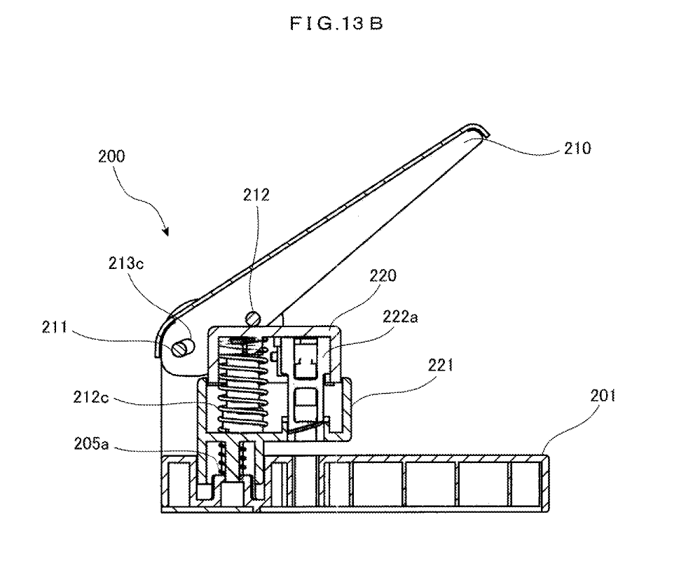

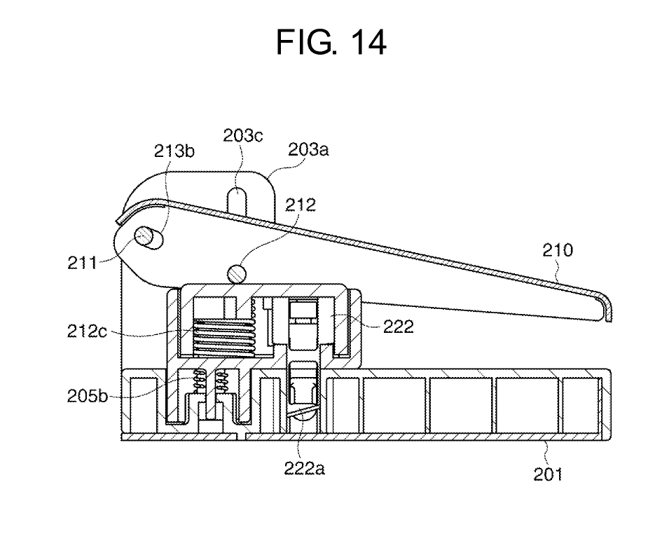

FIG. 13A is a schematic top view perspectively showing the appearance and internal structure of the paper binder 200. FIG. 13B is a schematic B-B cross-sectional view taken on cross section B-B in FIG. 13A, and showing the state of a pressing portion 221 before rotation of the handle 210. FIG. 14 is a schematic B-B cross-sectional view taken on cross section B-B in FIG. 13A, and showing the state of the pressing portion 221 after rotation of the handle 210. The configuration of the top plate 220 and the pressing portion 221 is similar to that in the first embodiment as shown in FIGS. 13A, 13B and 14.

That is to say, in the paper binder 200, a guide post 220a (FIG. 13A) and a guide post 220b (FIG. 13A) that project from the lower face of the top plate 220 toward the base 201 are formed. The guide posts 220a and 220b are inserted into first tubes 221a and 221b (FIG. 13A) that project from the pressing portion 221 toward the top plate 220. With this insertion configuration, the top plate 220 descends while being guided by the first tubes 221a and 221b. Furthermore, a first elastic member 221c is formed between the top plate 220 and the pressing portion 221, around the guide post 220a and the first tube 221a (FIGS. 7A and 8). In a like manner, a first elastic member 221d is formed around the guide post 120b and the first tube 221b (FIG. 9B). As the first elastic members 221c and 221d, for example, coil springs or rubber members are used.

Further, in a state that the handle 210 is most away from the base 201, the lengths of the first elastic members 221c and 221d are almost the same as a distance between the top plate 220 and the pressing portion 221. However, this length of the first elastic member 221c is merely one example, and the configuration of the paper binder 200 is not limited to this one. With this configuration, when the top plate 220 is pushed down, the first elastic members 221c and 221d shrink against the pressing force at first. Not shown in the drawings, a gauge table similar to that of the first embodiment can be formed in a second embodiment. As shown in FIGS. 13A and 9, a combination of the guide post, the first tube and the first elastic member may be formed not only in one pair but also in two pairs or three pairs, unlike in the paper binder of the first embodiment.

Furthermore, a projecting portion (not shown) that projects toward the base 201 is formed on the top plate 220 on the front side. The length of the projecting portion is shorter than the longest distance between the top plate 220 and the pressing portion 221, and slightly longer than the shortest distance therebetween, for example. Moreover, second elastic members 205a (not shown) and 205b (FIG. 14) that hit the projecting portion are formed on the base 201 at positions corresponding to the projecting portion.

The base 201 is equivalent to an example of a “base” and a “placement region” of the present invention. Moreover, the handle 210 is equivalent to an example of a “handling member” of the present invention. The top plate 220 is equivalent to an example of a “top portion” of the present invention. The pressing portion 221 is equivalent to an example including a “bottom portion” of the present invention.

### (Piercing Interval)

In a case that the paper binder 200 is configured to pierce a pair of holes at an interval of 80 mm and form each of the holes to be 6 mm in size, the holes meet the punch holes of the Japanese Industrial Standards (JIS). With such a configuration, it is possible to use the pierced holes as they are for filing into a two-hole file.

### (Actions and Effects)

As described above, the paper binder 200 is configured so that even when sheets of paper are flipped in the opposite direction to a direction that one of the tongues is inserted into one of the incisions, the other tongue engaged with the other incision can inhibit or prevent the sheets of paper from removing the tongue from the incision. Therefore, it is possible to secure the binding strength of sheets of paper. Moreover, since the sheets of paper are bound by the tongues, it is possible to bind the sheets of paper without using a binding material such as a staple or adhesive paste. Thus, it is possible to avoid a situation that a shredder or an ADF of a copier is damaged. Besides, since it is unnecessary to supply a binding material, it is possible to avoid complicated work for replacing the binding material even when continuously using the paper binder.

Next, technical ideas that can be obtained from the first and second embodiments will be additionally described below.
(1) The paper binder according to Claim 1, wherein:
   each of the punch blades and each of the projections are formed in one body;
   when the punch blades are pushed down toward the base together with the holder in accordance with rotation of the handling member, the sheets of paper placed on the base are pierced by the punch blades to form the strips, and the incisions are formed by the incising blades between the pierced holes; and
   when the holder is pushed down more after the strips and the incisions are formed, the tips of the projections rotate toward the incisions and fold the strips toward the incisions.
(2) The paper binder according to Claim 1, wherein:
   the base is provided with raised portions erected toward the handling member;
   the projections are supported by the holder so as to be rotatable; and
   when the holder is pushed down more after the strips and the incisions are formed, the raised portions hit part of the projections, the tips of the projections rotate toward the incisions, and the strips are folded toward the incisions.
(3) The paper binder according to Claim 1, wherein:
   a rotation shaft for rotating the handling member is inserted through the handling member and the supporting plates, and a pressure shaft is formed between a tip in a projection direction of the handling member and the rotation shaft;
   the base or the supporting plate is provided with a guide member that directly or indirectly guides a movement direction of the holder in accordance with rotation of the handling member; and
   when the handling member is rotated toward the base, the supporting members are pushed down via the pressure shaft, and guided by the guide member to move toward the base.
(4) The paper binder according to (3) described above, wherein:
   the guide member is provided with a post or a tube that is formed on the base and erected toward the holder, and a tube or a post that is engaged with the post or the tube and formed on the holder.
(5) The paper binder according to (3) described above, wherein:
   a placement region for placing the sheets of paper is formed between the holder and the base;
   the holder has a top portion that is in contact with the pressure shaft on the handling member side, and a bottom portion that presses the sheets of paper placed on the base; and
   the rotation shaft side is opened so that the sheets of paper can be inserted into the placement region from the rotation shaft side.
(6) The paper binder according to (3) described above, wherein:
   a placement region for placing the sheets of paper is formed between the holder and the base;
   the holder has a top portion that is in contact with the pressure shaft on the handling member side, and a bottom portion that presses the sheets of paper placed on the base; and
   the tip side of the handling member is opened so that the sheets of paper can be inserted into the placement region from the tip side of the handling member.
(7) The paper binder according to (5) or (6) described above, wherein:
   gauge tables are formed in pairs on a side to insert the sheets of paper on the base, at both sides of the base; and
   the gauge tables guide so that corners of the sheets of paper are held at a punch blade passing spot in the placement region.
(8) The paper binder according to (7) described above, wherein:
   each of the gauge tables is formed so that a height thereof is lower than a height from the base to the bottom portion; and
   the corners of the sheets of paper are guided so as to be held at the passing spot when the sheets of paper are passed between the gauge tables, whereas the sheets of paper are not guided when the sheets of paper are passed over the gauge tables and inserted into the placement region.

### (Modified Example)

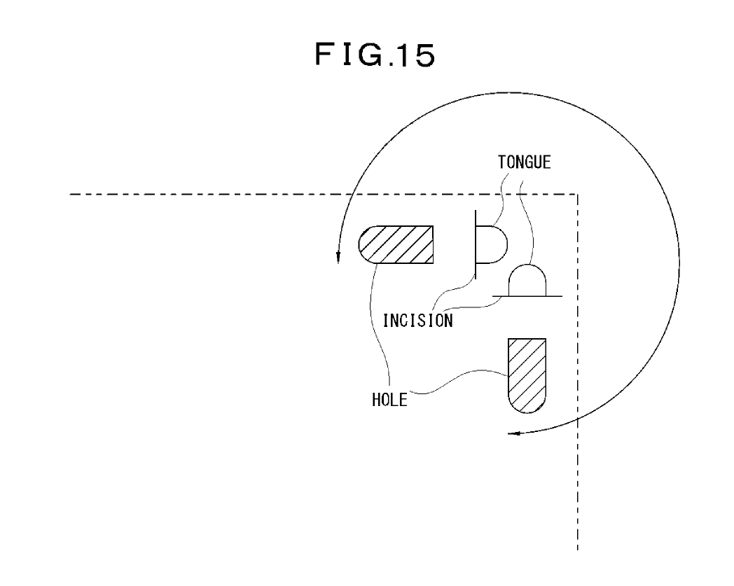

A modified example of the paper binders according to the abovementioned embodiments will be described below with reference to FIGS. 6, 12 and 15. FIG. 15 is a schematic view showing a state in which corners of sheets of paper are bound by the modified example of the paper binders 100 and 200.

Although the angle α as shown in FIGS. 6 and 12 is applied in the paper binders 100 and 200 according to the abovementioned embodiments, it is also possible to set the angle α to 90° in the case of binding corners of sheets of paper. Also with such a configuration, it is possible to secure a binding strength of the sheets of paper.

Further, the handle 210 of the second embodiment is provided with a long hole into which the rotation shaft 211 is inserted. Besides, the handle 210 is provided with a guide hole into which the pressure shaft 212 is inserted. However, a configuration with the first and second holes formed as in the handle 110 of the first embodiment shown in FIG. 8 may be applied to the paper binder 200 of the second embodiment. That is to say, the rotation shaft 211 and the pressure shaft 212 may be supported by holes having little play, respectively.

Further, the tongue processors 223a and 223b of the second embodiment are attached to the top plate 220 so that the projections 223e and 223f face each other and an angle formed by the tongue processors 223a and 223b is substantially 180°. However, the tongue processors 223a and 223b of the paper binder 200 of the second embodiment may be attached so as to be tilted with respect to the top plate 220 as in the first embodiment (refer to FIGS. 6 and 8).

### DESCRIPTION OF REFERENCE NUMERALS AND SYMBOLS

100, 200 paper binder
101, 201 base
101a, 201a raised portion
101c, 101d second tube
102 placement table
102a, 102b gauge table
103a, 103b, 203a, 203b supporting plate
104, 204 insertion opening
105a, 105b second elastic member
106a, 106b, 206a, 206b punch blade guide
110, 210 handle
111, 124a, 211, 224b rotation shaft
112, 212 pressure shaft
120, 220 top plate
120a, 120b, 220b guide post
121, 221 pressing portion
121a, 121b first tube
121c, 121d first elastic member
122 incising blade holder
122a, 122b, 222b incising blade
123a, 123b, 223a, 223b tongue processor
123c, 123d, 223c, 223d punch blade
123e, 123f, 223e, 223f projection
1201 projecting portion

1. A paper binder configured to partially cut and pierce stacked sheets of paper, form incisions near pierced holes, and engage substantially tongue-like strips formed by partially cutting with the incisions to bind the sheets of paper, the paper binder comprising:
a base;
a pair of supporting plates erected from both sides of the base;
a handling member supported by the supporting plates so as to be rotatable;
a pair of punch blades configured to pierce the sheets of paper and form the strips;
a pair of projections configured to be rotated in accordance with rotation of the handling member to hit the strips formed by the piercing and fold the strips toward the sheets of paper;
a pair of incising blades configured to form the incisions with which the strips can be engaged on the sheets of paper; and
a holder placed between the supporting plates, supported by the handling member or the base so as to be movable between the handling member and the base in accordance with rotation of the handling member, and configured to hold the punch blades and the projections and also hold the incising blades between the punch blades,
wherein the strips are folded so that, in accordance with directions of the projections held by the holder, rotation directions of the projections and projection directions of the strips face each other, respectively, and an angle formed by the facing strips is within a range of substantially 90°-180°.

2. The paper binder according to claim 1, wherein:
the handling member has a tip projecting in a direction away from the base with a rotation shaft side as a base portion;
the paper binder is provided with:
a rotation shaft inserted through the handling member and the supporting plates, and configured to rotate the handling member;
a pressure shaft placed near the rotation shaft, at a tip in a projection direction of the rotation shaft and the handling member, and configured to push down the holder toward the base when the handling member is rotated toward the base; and
guide holes formed on the base or the supporting plates, and configured to guide a movement direction of the pressure shaft in accordance with rotation of the handling member; and
an axial center of the rotation shaft locates on a perpendicular bisector of a line segment connecting both ends in a longitudinal direction of each of the guide holes.

3. The paper binder according to claim 1, comprising:
a rotation shaft inserted through the handling member and the supporting plates, and configured to rotate the handling member;
a pressure shaft inserted through the handling member and the supporting plates near the rotation shaft between the rotation shaft and a tip in a projection direction of the handling member, and configured to push down the holder toward the base when the handling member is rotated toward the base; and
a placement region to place the sheets of paper between the holder and the base, wherein:
the holder has a top portion being in contact with the pressure shaft on the handling member side, and a bottom portion pressing the sheets of paper on the base;
an elastic member configured to urge the top portion and the bottom portion in a direction away from each other is formed between the top portion and the bottom portion;
when the handling member is rotated, the top portion is pushed down against urging by the elastic member via the pressure shaft;
before the punch blades hit the sheets of paper on the base, a base-side face of the bottom portion is pressed against the sheets of paper by the pushed-down top portion, and the sheets of paper are held; and
when the handling member is rotated more, the top portion is pushed down more, and the punch blades pierce the held sheets of paper.

4. A paper binder configured to partially cut and pierce stacked sheets of paper, form incisions near pierced holes, and engage substantially tongue-like strips formed by partially cutting with the incisions to bind the sheets of paper, the paper binder comprising:
a base;
a pair of supporting plates erected from both sides of the base;
a handling member supported by the supporting plates so as to be rotatable;
a pair of punch blades configured to pierce the sheets of paper and form the strips;
a pair of projections configured to be rotated in accordance with rotation of the handling member to hit the strips formed by the piercing and fold the strips toward the sheets of paper;
a pair of incising blades configured to form the incisions with which the strips can be engaged on the sheets of paper; and
a holder placed between the supporting plates, supported by the handling member or the base so as to be movable between the handling member and the base in accordance with rotation of the handling member, and configured to hold the punch blades and the projections and also hold the incising blades between the punch blades,
wherein the holder is configured to hold the projections so as to face each other and so that an angle formed by connecting directions of the projections is within a range of substantially 90°-180°.
